(19) United States
(12) Patent Application Publication
(10) Pub. No.: US 2009/0066878 A1
(43) Pub. Date: Mar. 12, 2009

(54) Liquid Crystal Display Apparatus

(76) Inventors: Kenji Ogiro, Yokohama (JP); Nobuyuki Kaku, Oiso (JP); Fukuyasu Abe, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/167,335

(22) Filed: Jul. 3, 2008

(30) Foreign Application Priority Data
Sep. 11, 2007 (JP) 2007-234855

(51) Int. Cl. G02F 1/13357

(52) U.S. Cl. 349/62

(57) ABSTRACT

A liquid crystal display apparatus, comprises: a liquid crystal display (3); and a plural numbers of light emitting diodes (7), as a directly underlying type backlight, which is disposed on a rear surface of the liquid crystal display, so as to irradiate lights upon said liquid crystal display, wherein a translucent light guidance member (5), which is provided at least corresponding to each one or more of the plural numbers of light emitting diodes, and the translucent light guidance member (5) is in a cylindrical configuration, and reflection surfaces are defined on each of outer wall surfaces (53) and inner wall surfaces (52) of the cylindrical light guidance member, so as to reflect the lights from the light emitting diodes upon those reflection surfaces, and thereby guiding them onto a side of the liquid crystal display by those reflection surfaces.

### BACKGROUND OF THE INVENTION

The present invention relates to a liquid crystal display apparatus, and in particular, it relates to a liquid crystal display apparatus, in which elaboration is made for irradiating a light of a backlight upon a liquid crystal display, suitably, by means of light emitting diodes.

For the purpose of further increasing the picture quality or thin-sizing of the liquid crystal display, there is a case where the light emitting diodes (LED) are applied as the backlight. Also, accompanying with the large-sizing of the liquid crystal panel, the backlight method of applying the LED therein is shifted from a sidelight method (i.e., the method of disposing the LED on a side surface of the liquid crystal panel) into a directly underlying light method (i.e., the method of disposing the LED on the rear surface of the liquid crystal panel).

In general, since the LED is a point light source having a predetermined directivity, then it is necessary to irradiate the light, which is radiated from the LED directly underlying the liquid crystal display, uniformly as a surface light source upon the liquid crystal display.

As the conventional technology for equalizing or obtaining uniformity of the light from the LED, the followings are already known, which are described in the Patent Documents 1 through 3, for example.

The Patent Document 1 discloses therein a technology of providing a light control plate forming a purism structure for controlling the light emission direction from the light source, i.e., each LED, for each of a plural number of LED light sources, which are aligned on a circuit board.

The Patent Document 2 discloses therein a backlight device for guiding a light of a light source, which is disposed in a concave portion provided around a center on one surface of a transparent light guiding plate, by means of a light guiding plate, thereby emitting the light from an emission surface of that light guiding plate, and in particular, a technology of providing a concentric circle-like prism for reflecting the light from the light source, on the one surface of the light guiding plate.

Also, the Patent Document 3 discloses therein a technology of building up a translucent means for diffusing and polarizing the light from the light generating source (i.e., LED), from a polarizing material, having a characteristic of reflecting the light incident at a predetermined angle from the light generating source, and further providing a re-reflection member for reflecting the reflection light from that polarizing member, again thereon, so as to emit it to the translucent means.

[Patent Document 1] Japanese Patent Laying-Open No. 2006-344409 (2006);

[Patent Document 2] Japanese Patent Laying-Open No. 2007-48489 (2007); and

[Patent Document 3] Japanese Patent Laying-Open No. 2007-59146 (2007).

### BRIEF SUMMARY OF THE INVENTION

The technology described in the Patent Document 1 mentioned above takes the high-angle radiant light from the LED light source into no consideration thereof. Herein, the high-angle radiant light is a light emitted from the LED light source, having a large angle from the optical axis of the LED light source (i.e., the direction perpendicular to a light emitting plane), and it is the light emitted at an angle in the direction near to a main plane of the circuit board. Since the structures shown in the Patent Document 1 has the light control plate, which is provided at the opposite position on the light emission side of the LED light source, it is impossible to make such control that the high-angle radiant light directs to the side of the liquid crystal display.

The technology described in the Patent Document 2 shows the backlight device, wherein this light source is made up with the light emitting diodes, the entire side surfaces of which are made of the light emitting surfaces thereof. However, the structure of letting the lights propagate from a center of the light guiding plate to all of the directions is basically an application of the principle of a sidelight-type backlight, and therefore it has a drawback that brightness of the light is lowered down when separating from the light source; however, it never take such the drawback into the consideration thereof.

The technology described in the Patent Document 3 uses a lot of reflection members therein, so as to control the lights of a light source to propagate into a desired direction, and also the light emission source and the reflection members are made up in one body; therefore, the light source is complex in the structures thereof. Also, since the light emitted by the reflection members of the light emission source is determined by a positional relationship among the light emission source, the reflection members, and a prism sheet, therefore it is impossible to determine the performances as the backlight device, by itself, and also there is a necessity of determining the position where the light emission source should be provided, for each of the liquid crystal display apparatuses, and there is also possibility that the performances on brightness may be changed depending upon accuracy, in particular, in positioning the members mentioned above.

The present invention is accomplished by taking the drawbacks mentioned above into the consideration thereof, and an object thereof is to provided a technology of illuminating the liquid crystal panel having a large area, with uniformity and high brightness, within the liquid crystal display apparatuses applying the LED therein, as the backlight thereof.

For accomplishing the object mentioned above, according to the present invention, there is provided the liquid crystal display apparatus, which is described in the present pending claims attached herewith.

Thus, according to the present invention, there is provided a liquid crystal display apparatus, comprising: a liquid crystal display; and a directly underlying type backlight, which is disposed on a rear surface of said liquid crystal display, so as to irradiate lights upon said liquid crystal display, wherein said backlight is made of a group of plural numbers of light emitting diodes, and has a translucent light guidance member, which is provided at least corresponding to each one or more of said plural numbers of light emitting diodes, wherein said translucent light guidance member is in such cylindrical configuration, that it provides a light guiding portion in a direction perpendicular to a display surface of said liquid crystal display, and that a reflection surface is defined on each of outer wall surfaces and inner wall surfaces of said cylindrical light guidance member, whereby reflecting a light from said light emitting diode upon those reflection surfaces, and guiding it onto a side of said liquid crystal display by the light guidance member.

In the liquid crystal display apparatus, as described in the above, said cylindrical light guidance member may have a polygonal or circular cross-section, in parallel with the display surface of said liquid crystal display.

In the liquid crystal display apparatus, as described in the above, the inner wall surface and the outer wall surface of said light guidance member on the side of the liquid crystal display may be built up with parallel wall surfaces having a predetermined length thereof, and an end portion of the inner wall surface of said light guidance member on the side of said light emitting diode may be located at a position near to the side of said liquid crystal display than an end portion of the outer wall surface of said light guidance member, on the side of said light emitting diode, and an inclination surface may be defined or connected with, between an end portion of the parallel wall surface of said inner wall surface on the side of said light emitting diode and an end portion side of the parallel wall surface of the outer wall surface on the side of said light emitting diode.

In the liquid crystal display apparatus, as described in the above, on a surface opposite the side of said light guidance member on the side of said liquid crystal display may be formed a fine concave/convex light diffusion pattern for diffusing the light of said light emitting diode to emit it therefrom.

In the liquid crystal display apparatus, as described in the above, upon a surface opposite the side of said light guidance member on the side of said liquid crystal display is formed a fine concave/convex light diffusion pattern for diffusing the light of said light emitting diode to emit it therefrom. And further, upon the inclination surface of said light guidance member may be formed a prism pattern.

With such the structures of the present invention, as is described above, it is possible to irradiate the liquid crystal display having a large area thereof, equally or uniformly, with high brightness, in particular, within the liquid crystal display apparatus applying LED therein, as the backlight thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIGS. 1(a) and 1(b) are views for showing a liquid crystal display apparatus, according to an embodiment of the present invention;

FIG. 2 is a perspective view for showing a first embodiment of the backlight device, according to the present invention;

FIG. 3 is a cross-section view for showing the first embodiment of the backlight device, according to the present invention;

FIG. 4 is a cross-section view for showing a second embodiment of the backlight device, according to the present invention; and

FIGS. 5(a) to 5(c) are views for showing the manner of a high-angle radiant light to be incident upon a light guidance member 5.

### DETAILED DESCRIPTION OF THE PREFERRED EMBODIMENTS

Hereinafter, embodiments according to the present invention will be fully explained by referring to the attached drawings.

### Embodiment 1

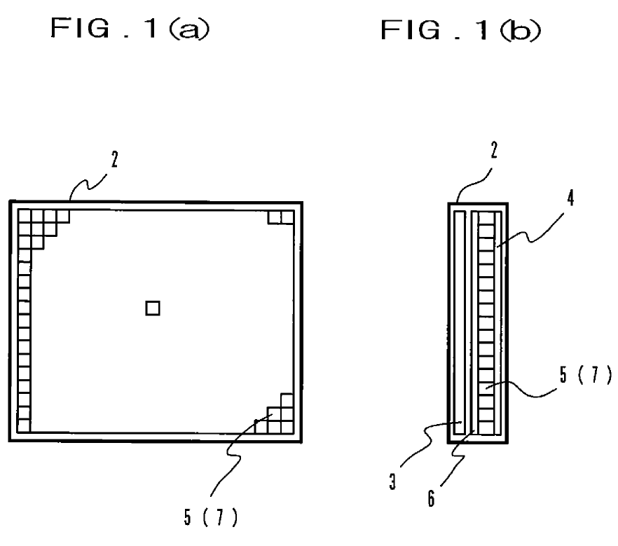

FIGS. 1(a) and 1(b) are views for showing a liquid crystal display apparatus, according to an embodiment of the present invention. In a front view shown in FIG. 1(a) is shown a liquid crystal display 3, fluoroscopically, i.e., a part of the constituent parts thereof, for the purpose of easy understanding of explanation. Within a housing 2 of the liquid crystal display apparatus 1 are disposed a liquid crystal display 3 for showing information thereon, a plural number of LED light sources (hereinafter, being called only by “LED”) 7, as backlight devices, on a rear surface of the liquid crystal display 3, and a circuit board 4, on which the LEDs 7 are mounted in a matrix manner. Between the circuit board 4 and the liquid crystal display 3 is provided a light guidance member 5, for illuminating the liquid crystal display 3 with high brightness, while applying the lights of LEDs 7 to be a surface light source. Further, there is provided a light diffusion member 6, being formed a plate-like or a sheet-like, for guiding the lights irradiated from the light guidance member 5 and/or the lights irradiated directly from the LEDs 7 upon the liquid crystal display 3, uniformly or equally. Herein, the light diffusion member 6 may be formed with the light guidance member 5, as a unit, in one body.

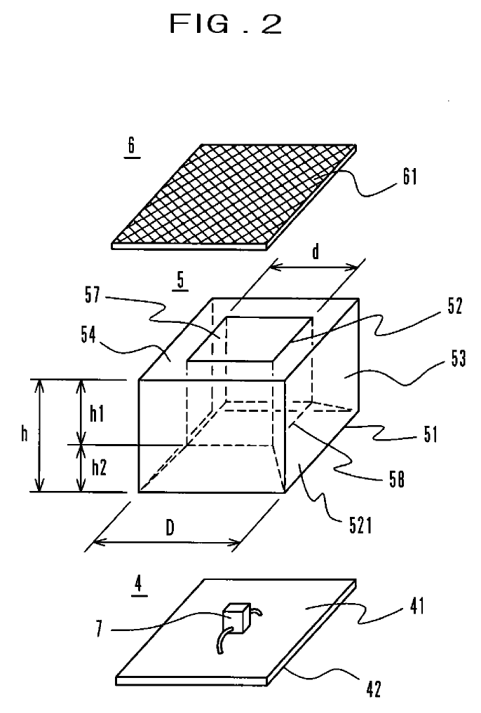

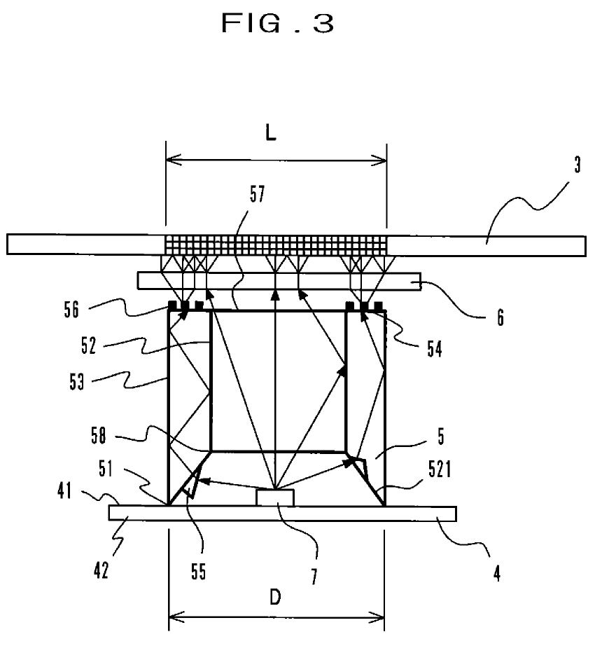

Next, explanation will be made on a first embodiment of the backlight device, according to the present invention, by referring to FIGS. 2 and 3. Herein, FIG. 2 is an explosive perspective view for showing an outline of the first embodiment, i.e., the backlight device according to the present invention, and FIG. 3 a cross-section view of that. However, although FIGS. 2 and 3 show therein only one (1) set of the backlight device for easy explanation, but actually, but this one (1) set of the backlight device are disposed in plural numbers thereof, vertically and horizontally, in a matrix manner, as was mentioned above. Also, a distance between the LEDs 7, which are disposed in the matrix manner, is determined by an amount of lights of the LED 7. Thus, it is so determined that a predetermined area of the liquid crystal display 3 can be irradiated with a desired brightness by one (1) LED 7.

Therefore, in the present embodiment, each one of the surface area of the circuit board 4, on which the plural number of LEDs 7 are mounted, a total of all the cross-section areas of the light guidance members 5, which are provided corresponding to each LED 7, and the surface area of the light diffusion member 6, comes to be nearly equal to the surface area of the liquid crystal display 3, respectively.

Herein, the backlight device, according to the present embodiment, comprises the light sources (i.e., LED) 7, which are mounted on the circuit board 4, as is shown in FIGS. 2 and 3, the light guidance members 5 for guiding the lights from the LEDs 7 to emit into a direction of the liquid crystal display 3, and the light diffusion member 6 for disusing the lights emitted from the light guidance members 5, thereby irradiating the lights upon the liquid crystal display 3. With this, it is possible to irradiate the lights of the LEDs 7 upon the liquid crystal display 3, uniformly and with high brightness. The light guidance member 5, according to the present embodiment, has a cylindrical shape for guiding the lights into the direction perpendicular to the display surface of the liquid crystal display, and defines reflection surfaces, respectively, on an inner wall surface and an outer wall surface thereof. With this, the lights from the LEDs 7 is reflected upon the reflection surfaces on the inner wall surface and the outer wall surface, respectively, and thereby are guided onto the liquid crystal display 3. The cylindrical light guidance member 5 has a quadrangular configuration, on the cross-section cut along a plane in parallel with the display surface of that liquid crystal display or a principle plane of the circuit board 4, in the present embodiment. More details of this light guidance member 5 will be mentioned, later.

Following to the above, explanation will be given in more details thereof, in particular, on the structures of the backlight structures, according to the present embodiment. The LEDs 7 are mounted on planes 41 of the circuit board 4, in particular, on the side of the liquid crystal display 3, and are electrically connected with wirings (not shown in the figure), which are provided on a plane 41 or an opposite plane 42 of the circuit board 4, through wire bonding or the like, i.e., being conductive with.

The light guidance member 5 is made up with a material having a transparency, such as, a translucent resin, for example. Also, the light guidance member 5 is mounted on the plane 41 of the circuit board 4, and defines a cylinder surrounding the peripheries of the LED 7 around a central axis in the direction perpendicular to the plane 41 of the circuit board 4. In other words, the light guidance member 5 defines a square pole, an inside of which is hollow, and it is disposed on the plane 41 of the circuit board 4, so that the LED 7 is located within that hollow portion 57. Further, the light guidance member 5, according to the present embodiment, is built up with a thick portion (i.e., a translucent resin portion), being defined by a inner wall surface 52 and an outer wall surface 53 thereof, as a light guidance portion, and further upon the inner wall surface 52 and the outer wall surface 53 are formed reflection surfaces, respectively. Therefore, the light guidance member 5, according to the present embodiment, builds up a combined light guidance portion comprising two (2) light guidance portions, i.e., the hollow portion 57 for disposing the LED 7 therein and the thick portion located around the LED 7. Herein, the inner wall surface 52 and the outer wall surface 53 are in parallel with each other, on each of the four (4) surfaces thereof.

However, although the light guidance member 5 is mentioned to be cylindrical in the configuration thereof, such as, the square pole, within the embodiment shown in FIGS. 2 and 3, being convenient for disposing the LED in a matrix manner, but the configuration of this cylindrical one on the plane may be a circle or may be other polygons. Also, within the present embodiment, only one (1) piece of light guidance member 5 is provided for one (1) piece of LED 7, but the light guidance member 5 may be so provided that it surrounds a subgroup of LEDs while assembling or gathering a plural number of LEDs (for example, 2 to 5 pieces) to be that subgroup. Thus, the light guidance member may be provided for each the plural number of LEDs, while making up the plural number of LEDs as a unit.

The light guidance member 5 is so disposed, for the purpose that the lights of LEDs can be irradiated, effectively, upon the liquid crystal display 3, that a lower end portion 51 thereof is in contact with or in vicinity of the plane 41 of the circuit board 4, on which the LEDs are disposed, and also it is so provided that it includes the LED 7 on the circuit board 4 within a hollow portion of the light guidance member 5. The size in the central axis direction (i.e., a height) of the light guidance member 5 is “h”, as is shown in FIG. 2. Herein, a lower end portion 58 of the inner wall surface 52 (i.e., an end portion on the side of LED 7) is located, shifting towards the light emission side of the LED 7 by a distance “h1” comparing to the lower end portion 51 (e.g., the end portion of the side of LED 7), i.e., on the side of the liquid crystal display 3. In other words, the position of the lower end portion 58 of the inner wall surface 52 is shifted towards the side of the liquid crystal display 3, by the distance “h1”. Also, the height of the inner wall surface 52 is “h2”, and since an upper end portion of the outer wall surface 53 and an upper end portion of the inner wall surface 52 are on the same plane, then “h”, “h1” and “h2” are in the relationship, i.e., h=h1+h2, as is shown in FIG. 2.

Further, the lower end portion 51 of the outer wall surface 53 and the lower end portion 58 of the inner wall surface 52 are connected with each other, at an inclination portion 521. Thus, between the lower end portion 51 of the outer wall surface 53 and the lower end portion 58 of the inner wall surface 52 is defined the inclination portion 521, and this inclination portion 521 has such configuration of expanding, gradually, towards the lower end portion of the outer wall surface 53.

Herein, the outer wall surface 53 of the light guidance member 5 is treated with such a process, that it functions as a reflection surface for reflecting the light incident upon the light guidance member 5, and thereby guiding it onto the liquid crystal display 3. Thus, it is so arranged that, basically, the light irradiated from the LED 7 and incident upon the light guidance member 5 will not go beyond, into an area outside the outer wall surface 53 of the light guidance member 5. Therefore, width (D) of the outer wall surface 53 of the light guidance member 5 is determined corresponding to a desired region (L) where the liquid crystal display 3 should be irradiated with a desired brightness. On the other hand, the width (d) of the inner wall surface 52 of the light guidance member 5 is determined upon basis of directivity of the LED 7, e.g., a directivity angle of the emission light from the LED (the details of which will be mentioned, later).

Further, upon the inclination surface (or portion) 521, which is provided in the lower portion of the light guidance member 5 (on the side of LED 7), there is made up with a prism pattern 55 (FIG. 3 illustrates an idealistic configuration, enlargedly) for entering the light from the LED 7 into the light guidance member 5 and guiding it into the direction of the liquid crystal display 3. Herein, it is assumed that the prism pattern 55 is formed all over the entire planes of the inclination surface 521. Also, a plane 54 on the upper side of the light guidance member 5, opposite to the liquid crystal display 3, is the surface provided for emitting the light therefrom, which is incident upon the light guidance member 5, and as is shown in FIG. 3, for example, upon which may be formed a concave/convex light diffusion pattern 56 for disusing the light so as to irradiate it upon the liquid crystal display 3. And, on the inner wall surface 52 is also treated with a process, such as, the reflection process, for obtaining a reflection surface thereon, to be a surface for reflecting a light reflecting upon the outer wall surface 53, or a surface for reflecting the high-angle radiant light direct from LED 7.

With the light guidance member 5, according to the first embodiment shown in FIGS. 2 and 3, since it has the cylindrical configuration, penetrating a hole up and down at a central portion thereof, due to the directivity of the LED 7, a low-angle radiant light is irradiated upon the liquid crystal display 3, directly from the hollow portion 57 at the center thereof. For this reason, the brightness at a portion of the liquid crystal display 3, corresponding to the hollow portion 57, comes to be very high, comparing to that of other portions, and therefore it results into a reason of generating an unevenness of the brightness upon the liquid crystal display 3. For the purpose of avoiding this, it is preferable to dispose the light diffusion member 6 for diffusing the light of the LED 7, in particular, between the light guidance member 5 and the liquid crystal display 3.

### Embodiment 2

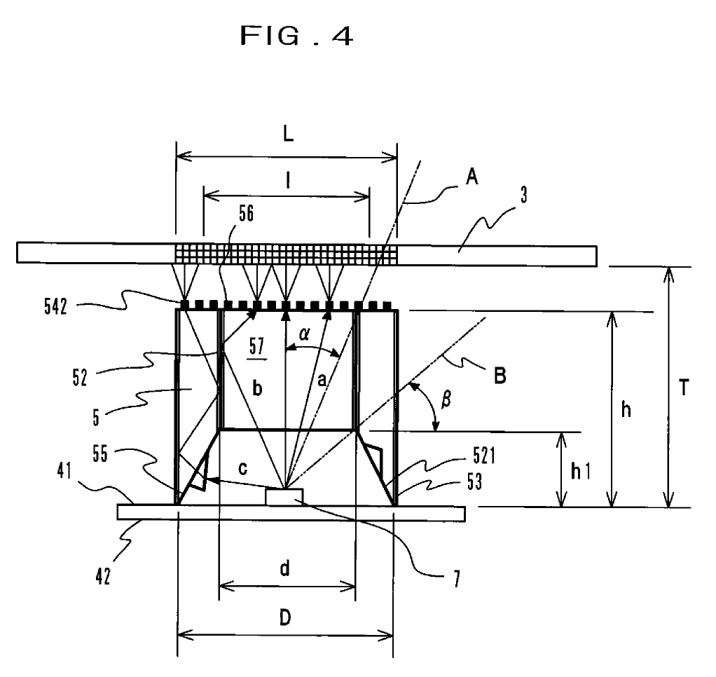

In the first embodiment mentioned above, the light diffusion member 6 and the light guidance member 5 are built up, separately, but the light diffusion member 6 and the light guidance member 5 may be built up within one body or as a unit. This will be explained as a second embodiment of the present invention, by referring to FIG. 4. In this FIG. 4, in an upper of the central portion of the light guidance member 5 (i.e., in a portion on the side of the liquid crystal display 3) is provided a light diffusion surface, on which the concave/convex light diffusion pattern 56 is formed, so that it covers the hollow portion 57. Thus, the present embodiment differs in an aspect that the upper portion of the hollow portion 57 is covered with the light diffusion surface 542, comparing to the first embodiment, but the structures and the functions of the inclination surface 521, the prism pattern 55, and the inner wall surface 52 and the outer wall surface 53 are same to those of the first embodiment.

The light guidance members, according to the present embodiment, builds up a box-like configuration, with the cylindrical light guidance member 5 having the hollow portion therein and the light diffusion surface 542, which is attached on the upper surface of the light guidance member 5, so as to cover the upper side thereof. Thus, the present embodiment, i.e., combining the light guidance member 5 and the light diffusion member 6, substantially, as a unit, has both the light guiding function within the first embodiment and the light diffusing function of the light diffusion member 6, together. Therefore, according to the present embodiment, it is possible to build up the backlight device for guiding and diffusing the light of LED 7 onto the liquid crystal display 3, in the structures being simple much more.

Next, explanation will be made on the condition where the light from the LED 7 is guided onto the liquid crystal display 3 by means of the light guidance member 5, by referring to FIG. 4, picking up three (3) lights (e.g., lights “a”, “b”, and “c”), as examples thereof. However, the condition of guiding the light from the LED 7, which will be mentioned below, is also same to that in the first embodiment, which was explained previously.

The light of the LED 7 has a predetermined directivity, and it is assumed that the directivity angle is “α”, which is determined by that directivity. The light “a” emitted from the LED 7 within this directivity angle “α”, i.e., the low-angle radiant light is incident upon the light diffusion surface 542, directly, but without incident (or entering) upon the inner wall surface 52 of the light guidance member 5. Herein, it is assumed that, the low-angle radiant light is the light, which is emitted from the LED 7 at a small angle to the optical axis of the LED 7 (herein, within the directivity angle “α”). Also, it is assumed that a boundary of the angle “α” is indicated by a straight line “A”. This low-angle radiant light is diffused by the concave/convex light diffusion pattern 56, which is formed on the light emission surface of the light diffusion surface 542, and is irradiated upon the liquid crystal display 3. With this, the light from the LED 7 can be irradiated, uniformly or evenly with high brightness, upon the liquid crystal display 3.

Herein, a region or area on the liquid crystal display 3, where the low-angle radiant light from the LED 7 can irradiate, directly, is an area within an inside than the position where the straight line “A” intersects with the liquid crystal display 3, in particular, the surface on the LED side. If assuming that the liquid crystal display 3 is irradiated only by the low-angle radiant light shown by the light “a” in FIG. 4, then it is possible to irradiate the low-angle radiant light upon the liquid crystal display 3, almost equally or uniformly, means of the light diffusion member 6, but without applying the light diffusion member 5 therein. However, in this case, the area on the liquid crystal display 3 comes to be narrow, where the LED 7 can irradiate the light thereupon, as is shown by “l” in FIG. 4. When trying to widen the area where the light can be irradiated up to “L” shown in FIG. 4, for example, it is necessary to elongate the distance of the LED 7 to the liquid crystal display 3. In this case, the liquid crystal display apparatus results to be large in the depth thereof, i.e., being disadvantageous for achieving the thin-sizing of that apparatus. Also, the distance from the LED 7 up to the liquid crystal display 3 comes far, and then it lowers down the brightness of the light irradiating the liquid crystal display 3, as a whole thereof. Also, when trying to dispose the LED 7 so that no unevenness can be generated in the brightness between the LEDs, while maintaining the radiation area (i.e., “l”), then it is necessary to narrow the disposition distances among the LEDs disposed, for each other, and for this reason, also the number of the LEDs to be used therein is increased.

For the purpose of obtaining a uniform picture or image of high brightness with the simple structures thereof, while obtaining the thin-sizing of the liquid crystal display apparatus 1 and also reduction of the number of the light sources, i.e., the LEDs 7, it is necessary to utilize, not only the low-angle irradiant light mentioned above, but also the lights “b” and “c”, i.e., the high-angle radiant lights having an emitting angle larger than the directivity angle “α” of the LED 7. According to the present embodiment, with utilizing such the high-angle irradiant lights, effectively, by means of the light guidance member 5 mentioned above, it is achieved to obtain an image of high picture quality, while thinning the size of the liquid crystal display apparatus 1 and also reducing the number of parts thereof.

Thus, as is shown in FIG. 4, the inner wall surface 52 of the light guidance member 5 is provided at the position where the straight line “A”, indicative of the boundary of the region of directivity angle “α”, intersects with the light diffusing surface 542. With this, the high-angle radiant lights, being larger than the directivity angle “α” of the LED 7, are incident upon the inner wall surface 52 of the light guidance member 5. Between the high-angle irradiant lights, i.e., the light “b” and the light “c”, the light having the emitting angle equal or larger than a critical angle (i.e., “β” degree) in the incident light from an air upon the light guidance member 5 (in this case, the light “b” for example) is incident upon the inner wall surface 52, to be reflected thereupon, and it is guided onto the light diffusion surface 542. For the purpose of reducing reflection loss on the inner wall surface 52, the inner wall surface is treaded with a reflection process is treated thereon.

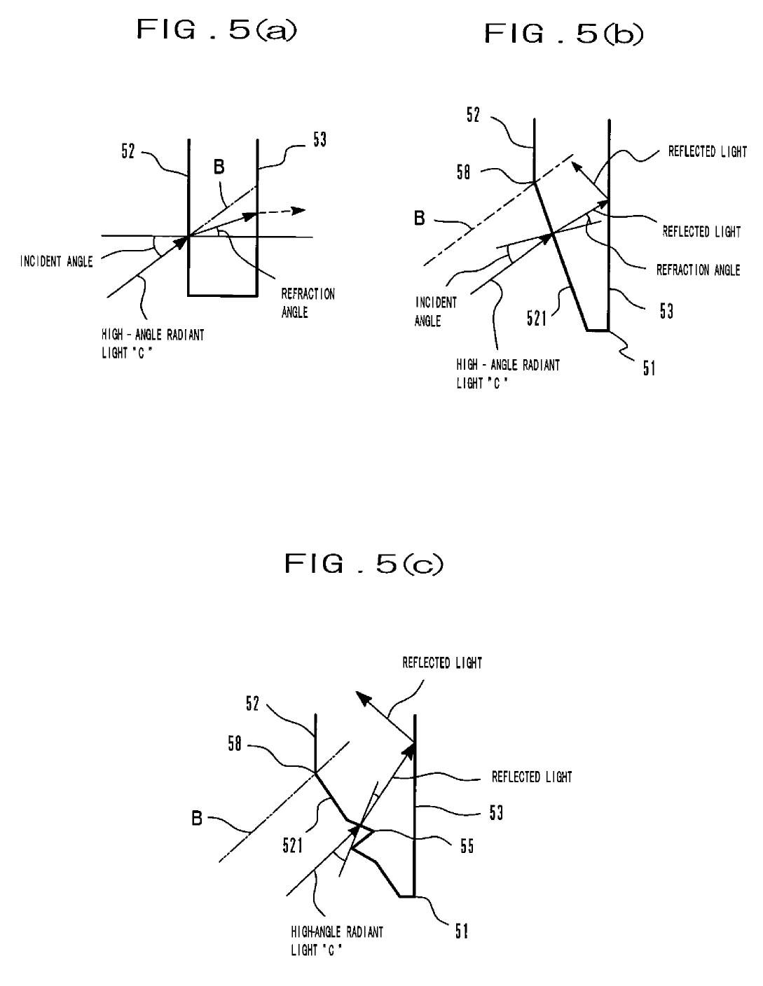

The light (c), i.e., the high-angle radiant light further higher than that critical angle “β” is refracted and incident upon the inclination surface 521 of the light guidance member 5. FIGS. 5(a) to 5(c) are views, for explaining the conditions of the high-angle radiant lights, each being incident upon the inclination surface 521, respectively. In particular, FIG. 5(b) explains the condition of the light, which is incident upon the inclination surface 521, and FIG. 5(c) the condition of the light, which is incident upon the prism pattern 55 provided on the inclination surface 521. Also, FIG. 5(a) shows the condition of guiding the light in the case where no inclination surface 521 is provided on the light guidance member 5, for the comparison.

As shown in FIGS. 5(b) and 5(c), the high-angle radiant light “c”, being incident upon the inclination surface 521, is refracted upon the inclination surface 521, to be changed the propagating direction thereof, and is incident upon the outer wall surface 53. The outer wall surface 53 is made of a reflection surface for irradiating the lights, entering or incident upon the light guidance member 5, upon the liquid crystal display 3, without loss thereof. Accordingly, the lights, which is incident upon this outer wall surface 53, is reflected upon that outer wall surface 53, or it is further totally reflected upon the inner wall surface 52, again, depending on the case, and thereby being guided onto the plane 54 on the upper surface portion or the upper side of the light guidance member of the light diffusion surface 542. With such the structures, the high-angle radiant light “c” is diffused on the concave/convex light diffusion pattern 56 of the light diffusion surface 542, or on the concave/convex light diffusion pattern 56 of the plane surface 54, thereby irradiating the liquid crystal display 3, equally or uniformly.

As is shown in FIG. 5(b), starting from a point where a straight line “B” indicative of the boundary of the region of this critical angle “β” intersects with the inner wall surface 52 (i.e., a lower end portion 58 of the inner wall surface 52), the inclination surface 521 is defined, directing to the lower end portion of the light guidance member 5. This inclination surface 521 has such a configuration that it expands, gradually, directing to the lower portion of the light guidance member 5. In this manner, with provision of the inclination surface 521 on the inclination surface 521 enables to enlarge an incident angle of the high-angle radiant lights directing onto the outer wall surface 53, with respect to that outer wall surface 53. In case of not providing this inclination surface 521, as is shown in FIG. 5(a), the incident angle of the high-angle radiant light comes to be small upon the outer wall surface 53, and the high-angle radiant light increases the number of repetition of reflections between the outer wall surface 53 and the inner wall surface 52. Therefore, according to the present embodiment, the incident angle of the high-angle radiant light upon the outer wall surface 53 is enlarged by means of the inclination surface 521, so as to enable generation of the total reflection of the high-angle radiant light upon the outer wall surface 53, easily.

Also, as is shown in FIG. 5(c), the prism pattern 55 may be formed on the inclination surface 521. With this, it is possible to direct the propagating direction of the light incident upon the inclination surface 521 into the side of the liquid crystal display 3, as early as possible, and further it is also possible to enlarge the incident angle thereof upon the outer wall surface 53, so as to generate the total reflection thereon, more easily.

The light guidance member 5, according to the present embodiment, is able to irradiate each of the low-angle radiant light and the high-angle radiant lights of the LED 7, respectively, through the most suitable method, corresponding to the directivity of the LED 7, with reducing the loss thereof. Thus, with the light guidance member 5, according to the present embodiment, it is possible to guide the reflection lights into the irradiation direction while reducing the loss or down to zero. With this, according to the present embodiment, it is possible to utilize the point-like light source of the LED 7 as the surface-like light source for the liquid crystal display 3, and thereby obtaining the liquid crystal display apparatus of picture quality, being much more equal and high in the brightness, while achieving the thin-sizing of the apparatus.

However, both the inner wall surface 52 and the outer wall surface 53 have the plane-like configuration, and the process treated upon the reflection surfaces thereof can be conducted by sticking a sheet member or the like, having a high-reflective characteristic, on the light guidance member 5. Alternatively, they may be built up, by pasting a paint of the high reflectivity on the inner wall surface 52 and the outer wall surface 53 of the light guidance member 5, or evaporating a metal of high reflectivity thereon, such as, aluminum or silver, etc.

With the one (1) set of the backlight device is built up with, using the light guidance member 5 having the size (D) nearly equal to the irradiation area (L), according to the present embodiment, for the purpose of irradiating the predetermined area (L) on the liquid crystal display 3 with the desired brightness, then it is possible to determine the light irradiation capacity of the one (1) set of the backlight device, appropriately, and also to maintain the same performances or conditions thereof. Therefore, with making up the liquid crystal display 3 while combining a plural number of that one (1) set of the backlight devices corresponding to the display area thereof, it is possible to provide a backlight device corresponding to a desired screen size, and also to obtain a predetermined brightness, easily, irrespective of the screen size thereof.

Also, even the backlight device can be made up, by combining the small-sized small backlight devices, corresponding to the large screen, then it is possible to deal with a small-scaled manufacturing facility, in particular, in the production of the light guidance member, etc., and also to achieve an efficiency of production, with omitting a new development corresponding to the screen size. Further, since it is enough to produce the same thing (i.e., small-sized small backlight device), in a large number thereof, and then there can be achieved an effect of reducing the price thereof, etc.

However, the plural pieces of the backlight devices may be combined by holding them by means of a frame member, or the backlight devices themselves are combined with each other through adhesion therebetween.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A liquid crystal display apparatus, comprising:
a liquid crystal display; and
a directly underlying type backlight, which is disposed on a rear surface of said liquid crystal display, so as to irradiate lights upon said liquid crystal display, wherein
said backlight is made of a group of plural numbers of light emitting diodes, and has
a translucent light guidance member, which is provided at least corresponding to each one or more of said plural numbers of light emitting diodes, wherein
said translucent light guidance member is in such cylindrical configuration, that it provides a light guiding portion in a direction perpendicular to a display surface of said liquid crystal display, and that a reflection surface is defined on each of outer wall surfaces and inner wall surfaces of said cylindrical light guidance member, whereby reflecting a light from said light emitting diode upon those reflection surfaces, and guiding it onto a side of said liquid crystal display by the light guidance member.

2. The liquid crystal display apparatus, as described in the claim 1, wherein said cylindrical light guidance member has a polygonal or circular cross-section, in parallel with the display surface of said liquid crystal display.

3. The liquid crystal display apparatus, as described in the claim 1, wherein
the inner wail surface and the outer wall surface of said light guidance member on the side of the liquid crystal display are built up with parallel wall surfaces having a predetermined length thereof, and
an end portion of the inner wall surface of said light guidance member on the side of said light emitting diode is located at a position near to the side of said liquid crystal display than an end portion of the outer wall surface of said light guidance member, on the side of said light emitting diode, and an inclination surface is defined between an end portion of the parallel wall surface of said inner wall surface on the side of said light emitting diode and an end portion side of the parallel wall surface of the outer wall surface on the side of said light emitting diode.

4. The liquid crystal display apparatus, as described in the claim 1, wherein
on a surface opposite the side of said light guidance member on the side of said liquid crystal display is formed a fine concave/convex light diffusion pattern for diffusing the light of said light emitting diode to emit it therefrom.

5. The liquid crystal display apparatus, as described in the claim 2, wherein
on a surface opposite the side of said light guidance member on the side of said liquid crystal display is formed a fine concave/convex light diffusion pattern for diffusing the light of said light emitting diode to emit it therefrom.

6. The liquid crystal display apparatus, as described in the claim 3, wherein
on a surface opposite the side of said light guidance member on the side of said liquid crystal display is formed a fine concave/convex light diffusion pattern for diffusing the light of said light emitting diode to emit it therefrom.

7. The liquid crystal display apparatus, as described in the claim 1, wherein a light diffusion member is disposed between said light guidance member and said liquid crystal display, for diffusing lights from the group of said light emitting diodes and lights guided by said light guidance member thereon.

8. The liquid crystal display apparatus, as described in the claim 2, wherein a light diffusion member is disposed between said light guidance member and said liquid crystal display, for diffusing lights from the group of said light emitting diodes and lights guided by said light guidance member thereon.

9. The liquid crystal display apparatus, as described in the claim 3, wherein a light diffusion member is disposed between said light guidance member and said liquid crystal display, for diffusing lights from the group of said light emitting diodes and lights guided by said light guidance member thereon.

10. The liquid crystal display apparatus, as described in the claim 4, wherein a light diffusion member is disposed between said light guidance member and said liquid crystal display, for diffusing lights from the group of said light emitting diodes and lights guided by said light guidance member thereon.

11. The liquid crystal display apparatus, as described in the claim 5, wherein a light diffusion member is disposed between said light guidance member and said liquid crystal display, for diffusing lights from the group of said light emitting diodes and lights guided by said light guidance member thereon.

12. The liquid crystal display apparatus, as described in the claim 6, wherein a light diffusion member is disposed between said light guidance member and said liquid crystal display, for diffusing lights from the group of said light emitting diodes and lights guided by said light guidance member thereon.

13. The liquid crystal display apparatus, as described in the claim 4, wherein upon the inclination surface of said light guidance member is formed a prism pattern.

14. The liquid crystal display apparatus, as described in the claim 5, wherein upon the inclination surface of said light guidance member is formed a prism pattern.

15. The liquid crystal display apparatus, as described in the claim 6, wherein upon the inclination surface of said light guidance member is formed a prism pattern.
